(19) United States
(12) Patent Application Publication
(10) Pub. No.: US 2014/0270472 A1
(43) Pub. Date: Sep. 18, 2014

(54) TIERED LATENCY OF ACCESS FOR CONTENT

(71) Applicant: ELWHA LLC, Bellevue, WA (US)

(72) Inventors: Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Tony S. Pan, Cambridge, MA (US); Lowell L. Wood, JR., Bellevue, WA (US)

(21) Appl. No.: 13/795,612

(22) Filed: Mar. 12, 2013

(51) Int. Cl. G06T 7/00

(52) U.S. Cl. CPC G06T 7/0004
USPC 382/147

(57) ABSTRACT

A method substantially as shown and described in the detailed description and/or drawings and/or elsewhere herein. A device substantially as shown and described in the detailed description and/or drawings and/or elsewhere herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1, including FIGS. 1A to 1Y shows a partially schematic diagram of an environment(s) and/or an implementation(s) of technologies described herein. The figures are ordered alphabetically, first by increasing column from left to right, then by increasing row from top to bottom, as shown in the following table:

TABLE 1
Alignment of drawings.

| | | | | |
|---|---|---|---|---|
| FIG. 1A | FIG. 1B | FIG. 1C | FIG. 1D | FIG. 1E |
| FIG. 1F | FIG. 1G | FIG. 1H | FIG. 1I | FIG. 1J |
| FIG. 1K | FIG. 1L | FIG. 1M | FIG. 1N | FIG. 1O |
| FIG. 1P | FIG. 1Q | FIG. 1R | FIG. 1S | FIG. 1T |
| FIG. 1U | FIG. 1V | FIG. 1W | FIG. 1X | FIG. 1Y |

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

With reference now to the Figures and with reference now to FIG. 1, FIG. 1 shows a partially schematic diagram of an environment(s) and/or an implementation(s) of technologies described herein. It is noted that FIG. 1 is a high-level environment diagram. As such, some elements of the system illustrated in FIG. 1 are expressed as circuitries and modules. The various circuitries (e.g., content processor circuitry 1-100, content distributor circuitry 2-100, Tag Providing Circuitry 3-100, and so forth) illustrated in FIG. 1 may be implemented using a variety of hardware including, for example, customized circuitry such as application specific integrated circuit (ASIC) and/or programmable type hardware such as a microprocessor or a controller executing one or more programming instructions or field programmable gate array (FPGA) executing one or more programming instructions. In some cases, the various illustrated circuitries may be implemented at one or more network devices such as one or more network servers. Other elements illustrated in FIG. 1 are described as modules and the functions they carry out. Such elements (e.g., modules) should be considered to include purely dedicated hardware components (e.g., ASIC), or any combination of hardware and software (e.g., a microprocessor, a controller, or a FPGA executing computer readable programming instructions).

The environment illustrated in FIG. 1 includes a system that is able to, among other things, provide different levels of access/fees for accessing content. More particularly, in some implementations, the system illustrated in FIG. 1 may be capable of providing tiered levels of access latency and fees for accessing content.

The rapid development of computing and related technologies over the last several decades have resulted in the ever growing demand for content, sometimes in a very timely manner. The word “content” for purposes of this description may be in reference to any one or more of a wide variety of data/information that may be available through today's computing and/or networking technologies. Some examples of content include news (e.g., business or financial news such as stock or commodities prices, celebrity news, agricultural news, sports news, and so forth), information provided through social media, movies, soundtracks, sporting events, and so forth. In many instances, content receivers 40 (e.g., content consumers 70 such as individual end users, or aggregators 50 such as Google, Yahoo, MSN, etc.) may want to pay a premium in order to be able to be the first ones to access a particular content or be able to access the particular content before anyone else has a chance to access such content. Well-known examples of such scenarios can be found, for example, in the financial markets where early knowledge of certain financial information may provide huge advantages for those gaining such early knowledge.

FIG. 1 depicts one or more raw content providers 10 that provide raw content data 12, which in some implementations may be provided to a content processor circuitry 1-100. Examples of raw content providers 10 include, for example, Dow Jones, Nasdaq, Associated Press, Reuters, Bloomberg, New York Times, HBO, Warner Brothers, Columbia Pictures, NBC Universal, Walt Disney Pictures, Universal Music Group, Sony Music Entertainment, Warner Music Group, Electronic Arts, Nintendo, Twitter or other social media such as Facebook, Police or Fire Department Channels, and so forth. In various embodiments, the content processor circuitry 1-100 may be designed to, among other things, initially analyze the received raw content data 12 in order to identify and/or categorize the received raw content data 12 (e.g., determining what type of information is the raw content data 12 including whether it is news, and if it is news, whether it is, for example, business, financial or celebrity news for example).

In various implementations, the content processor circuitry 1-100 may further be designed to process the raw content data 12 in order to, for example, provide a more usable or digestible form of content data 14 that may be referred to herein as simply “content.” In other cases, however, the raw content data 12 received by the content processor circuitry 1-100 may be minimally processed. In such situations, the content data 14 provided by the content processor circuitry 1-100 may be the same or substantially the same as the raw content data 12 that was received by the content processor circuitry 1-100. In embodiments where the content processor circuitry 1-100 processes the raw content data 12 in order to generate the content data 14, the content processor circuitry 1-100 may supplement the raw content data 12 with additional data such as contextual data in order to generate the resulting content data 14. For example, in some embodiments, the content processor circuitry 12 may add background information including historical data to the raw content data 12 in order to generate the content data 14 (e.g., in the case where the raw content data 12 relates to financial market data, adding historical market data to provide context to the raw content data 12).

As further illustrated in FIG. 1, in some implementations, the content processor circuitry 1-100 may include one or more logic modules including, for example, a raw content data acquiring module 1-102, a raw content data processing module 1-104 (which may further include a content analyzing module 1-105, a content formatting module 1-106, and/or a content supplementing module 1-107), and/or a content data relaying module 1-108. In various implementations, the content data 14 that may be provided by the content processor circuitry 1-100 may be relayed to the content distributor circuitry 2-100 as illustrated in FIG. 1.

As further illustrated in FIG. 1, the content distributor circuitry 2-100 may be designed to perform various functionalities including, for example, further distributing the received content data 14 to a tag providing circuitry 3-100 and/or content receivers 40 (e.g., aggregators 50, platform/browser 60, and/or content consumers 70). In various implementations, the content distributor circuitry 2-100 may be able to distribute the content data 14 in at least two alternative ways. For example, in some implementations, the content distributor circuitry 2-100 may be designed to actively send or deliver the content data 14 while in other implementations the content data 14 may simply be made available (e.g., accessible). In some implementations, the content distributor circuitry 2-100 may be, prior to distributing the received content data 14, designed to modify and/or supplement with additional data the received content data 14.

In various embodiments, the content distributor circuitry 2-100 may be designed to distribute (e.g., make available or transmit) a particular content data 14 to, for example, one or more content receivers 40 in accordance with a listing of delivery time delays. For example, a particular content receiver 40 (e.g., an aggregator 50, a platform/browser 60, and/or a content consumer 70) that is designated for receiving a particular content data 14 may only be able to access such content data 14 only after a specified amount of delivery time delay (e.g., a time delay that is specifically associated with the particular content receiver 40 with respect to the particular content data 14) has passed. The specified amount of delivery time delay may be as a result of the particular content receiver 40 agreeing to pay for such access (e.g., paying a higher fee for earlier access). Thus, the content distributor circuitry 2-100 in some cases may be designed to “release” a particular content data 14 to different groups of content receivers 40 at different points in time based, for example, on a listing of delivery time delays that were obtained based on the various accesses and fees agreed to by the different groups of content receivers 40. In various embodiments, the delivery time delays may be acquired from, in some cases, a billing circuitry 5-100. Alternatively the delivery time delays may be acquired from a bidding circuitry 4-100.

In some implementations, the content distributor circuitry 2-100 may be designed to distribute view tags 22 along with content data 14. In various embodiments, the view tags 22 that may be distributed may provide information related to content receivers 40 who may have previously accessed (e.g., viewed) the content data 14 to be distributed. Among other things, view tags 22 may indicate when/who/how many content receivers 40 may have previously accessed a particular content data 14. For example, suppose there are two groups of content receivers 40 that are designated for receiving a particular content data 14 at two different points in time: a first group of content receivers 40 and a second group of content receivers 40 who will be receiving the particular content data 14 at a second point time that is later than a first point in time that the first group of content receivers 40 will be receiving the particular content data 14. In this example scenario, the second group of content receivers 40 may receive view tags 22 that may indicate who and how many content receivers 40 (e.g., the first group of content receivers 40) have already received the content data 40. Such information may be particularly useful in, for example, the business/financial industry.

In some cases, the view tags 22 may be generated based on read information 23 provided by the content receivers 40 who have already accessed content data 14. In some cases, read information that may be received from the one or more content receivers 40 may essentially be the same as the information included in view tags 22 distributed by the content distributor circuitry 2-100. In some cases, the read information 23 may be collected by the content distributor circuitry 2-100 and may then be relayed to the tag providing circuitry 3-100 in order to generate view tags 22.

In various embodiments, the content distributor circuitry 2-100 may be designed to have various other functionalities. For example, in some implementations, the content distributor circuitry 2-100 may be able to deny access of certain content data 14 to particular content receivers (e.g., an aggregator 50). Alternatively or additionally the content distributor circuitry 2-100 may be designed to degrade the content data 14 that may be distributed (e.g., providing a degraded version rather than the full version of the content, or provide or attach a warning related to the content data 14 to be distributed). In some cases, the content distributor circuitry 2-100 may be able to make a particular content (e.g., a particular content data 14) available for free after a maximum delivery time delay has passed. In some implementations, a particular content (e.g., particular content data 14) may be distributed to various content receivers 40 using different communication links (e.g., communication lines) having different bandwidth and latency. In some implementations, the content distributor circuitry 2-100 may be designed to provide advertisements along with content. In some cases, by providing one or more advertisements before providing a particular content, latency requirements for the content may be realized.

As further illustrated in FIG. 1, the content distributor circuitry 2-100 may include one or more logic modules including, for example, a content data acquiring module 2-102, a delivery time delay acquiring module 2-104 (which may further include a soliciting module 2-106 and/or a receiving module 2-108), and/or a content data relaying module 2-110 (which may further include a view information relaying module 2-112).

In various embodiments, the tag providing circuitry 3-100 illustrated in FIG. 1 may receive content data 14 and/or read information 23 in order to provide one or more bidding tags 20 and/or one or more view tags 22. The bidding tags 20 that may be generated by the tag providing circuitry 3-100 may be relayed to, for example, content receivers 40 in order to solicit bids (e.g., bids for accessing content data 14) from the content receivers 40. The bidding tags 20 may provide non-specific generic information related to the content (e.g., content data 14) that is being bid on. That is, bidding tags 20 may be generated in order to solicit bids for content that may or may not already exist. For example, in some cases, bidding tags may provide general non-specific information related to content that is yet to exist (e.g., a bidding tag 20 that identifies the type and date of a financial report that is to be published on a future date, or a name of a celebrity “Lindsey Lohan” and the type of future news, e.g., criminal, related to that celebrity that is of interest).

In other cases, bidding tags 20 may provide non-specific information related to an already existing content (e.g., a bidding tag 20 related to news of a particular celebrity without identifying specifically what the news was about or the identity of the celebrity, or news related to a price for a particular stock or commodity without identifying what that price is). In embodiments where content (e.g., content data 14) already exists, a bidding tag 20 may be generated based on content data 14 provided by the content distributor circuitry 2-100. In alternative embodiments where content data 14 does not yet exist, a bidding tag 20 may be generated based on preexisting information (e.g., name of a celebrity or stock of interest, date of interest, type of news, etc.). In some embodiments, a bidding tag 20 may be based on one or more keywords (e.g., IBM, price, stocks, commodities, arrest, Lindsey Lohan, etc.), perceived importance of the corresponding content (e.g., content data 14), metadata that may have been provided (e.g., as provided by the raw content provider 10) with the content, and so forth. In various embodiments, the bidding tags 20 provided by the tag providing circuitry 3-100 may be provided to a bidding circuitry 4-100 as illustrated in FIG. 1.

The view tags 22 that may be generated by the tag providing circuitry 3-100 may be generated based on read information 23 provided by content receivers 40 or by the content distributor circuitry 2-100. As further illustrated in FIG. 1, the generated view tags 22 may be relayed to content distributor circuitry 2-100. In various embodiments, the generated view tags 22 may be based on who and what are the content receivers 40, the number of content receivers 40 who had previous access to the content, and the number of times that the content (e.g., content data 14) has been accessed. In many cases, the “exclusivity” of information may be valuable to certain content consumers 70. For example, for certain content consumers 70, such as traders, may want to know at least blind versions of who/when were content (e.g., financial market news) was viewed or accessed. Also, such features may be socially valuable when the content originates from social networking channels (e.g., Twitter feeds).

In various embodiments, the tag providing circuitry 3-100 may include one or more logic modules (including, for example, a content receiving module 3-102, a read information receiving module 3-103, a bidding tag providing module 3-104, and/or a view tag providing module 3-106.

In various embodiments, the bidding circuitry 4-100 illustrated in FIG. 1 may be designed to relay the modified or unmodified versions of the bidding tags 20 received from the tag providing module 3-100 to content receivers 40 in order to solicit or obtain one or more bids 24 from the content receivers 40 for accessing content (e.g., content data 14). After transmitting the bidding tags 20, the bidding circuitry 4-100 may receive one or more bids 24 from one or more content receivers 40.

In some alternative implementations, the one or more bids 24 that may be received by the bidding circuitry 4-100 from one or more content receivers 40 may be received without the bidding circuitry 4-100 having had to initially transmit bidding tags 20 that were based on the existing content data 14. For example, such bids 24 may be received without the bidding tags 20 (e.g., bidding tags 20 that are based on already existing content data 14) being previously transmitted if the content receivers 40 are bidding for future content that does not yet exist but that will exist in the future (e.g., a regularly generated market or commodities report, release of a movie, etc.), or are bidding for a future content (e.g., a news event that is yet to occur such as a particular celebrity getting arrested) that although not guaranteed to occur will likely or predictably occur and/or can be characterized and generalized (e.g., “celebrity arrest news”). In such cases, the bidding circuitry 4-100 may be designed to receive bids 24 without first relaying bidding tags 20 (since the content receiver 40 may already know what they want to bid for), or alternatively may relay bidding tags 20 that are not based on content data 14 that already exists (e.g., such bidding tags 20 may be based on already known parameters such as “celebrity arrest news” or “financial market news on Apr. 1, 2016”).

In various implementations, the bids 24 that may be received by the bidding circuitry 4-100 may be processed by the bidding circuitry 4-100 in order to determine (e.g., identify as well as assign), for example, one or more delivery time delays for one or more content receivers 40 who are or will be given access to the content data 14 based on their bids 24. That is, in various implementations, the bidding circuitry 4-100 may be designed to, upon receiving the bids 24, first determine which content receivers 40 are to have access/receive the content data 14, and second, determine the type of access (e.g., the delivery time delay) that each of the content receivers 40 (who were determined to be getting access to the content data 14) will actually be getting. Obviously those content receivers 40 who provide the highest bids will, in many instances, receive the greatest access (e.g., shortest delivery time delay) to the content data 14. Note that in some embodiments, greater access to content data 14 may mean that in addition to having a shorter delivery time delay for accessing the content data 14 greater contextual data (e.g., background information) may be provided with the content data 14.

In various embodiments, the bids 24 that may be received by the bidding circuitry 4-100 may be for a fixed delivery time delay at a fixed price. In other words, the bids 24 that may be received may be in response to a solicitation (e.g. which may be in the form of a bidding tag 24) from the bidding circuitry 4-100 soliciting for accessing content data 14 for a fixed price and with a fixed delivery time delay. In some cases, the bids 24 that are received may be sorted and resolved in auction style (e.g., higher bids with greater monetary values getting greater access to content).

In some embodiments, the bidding circuitry 4-100 may be designed to receive bids 24 from certain content receivers 40 for increasing the delivery time delays for other content receivers 40 who may also be bidding to receive the same content. For example, suppose two content receivers 40 are bidding to access a particular content, then one or both of the content receivers 40 may submit bids to have the delivery time delay of the other content receiver 40 be increased.

As further illustrated in FIG. 1, the bidding circuitry 4-100 may include one or more logic modules including, for example, a bidding tag receiving module 4-102, a bid soliciting module 4-104 (which may further include a bidding tag relaying module 4-105), a bid receiving module 4-106, a bids processing module 4-108, an access level providing module 4-110, and an access level (delivery time delay) providing module 4-112.

Referring now to the billing circuitry 5-100 of FIG. 1, which may be designed to receive certain information from the bidding circuitry 4-100 in order to, for example, generate billings. The information that may be received from the bidding circuitry 4-100 may include information that at least identifies those content receivers 40 who have been allowed or given access to content (e.g., content data 14). The information provided to the billing circuitry 5-100 may additionally or alternatively include access levels (e.g., delivery time delays) for each content user (e.g., content receiver 40) who have been given access to content (e.g., content data 14). The amount of fees that each content user will be charged may depend on, of course, the level of access that they have been given for accessing the content. In some cases, the billing or bills generated by the billing circuitry 5-100 and that are sent to content users (e.g., content receivers 40) may be based on read information 23 provided by the content users themselves. In various implementations, the read information 23 that is provided by one or more content users (e.g., content receivers 40) may at least indicate which content (e.g., content data 14) has been accessed by the one or more content users.

Referring now to the content receivers 40 illustrated in FIG. 1. In various embodiments, the content receivers 40 may comprise of aggregators 50, platform/browsers 60, and content consumers 70 (e.g., end users). Aggregators 50 may be any (network) entity who may aggregate various content. Examples of aggregators include, for example, Google, Yahoo, MSN, Huffington Post, MarketWatch, and so forth. Typically aggregators 50 will not be the end point for the content that they have collected. That is, aggregators 50 will often pass on the content that they have acquired to content consumers 70 via platform/browsers 60. In some cases, aggregators 50 may detect and record when, who, and how many platform/browsers 60 and/or content consumers 70 have accessed (e.g., read) content that was provided by the aggregators 50.

In many cases, content consumers 70 will access content through platforms/browsers 60 (e.g., platforms and/or browsers). Examples of platforms and browsers include, for example, Apple TV, Google TV, tablet computers (e.g., Kindle Fire, iPad, or Samsung Galaxy), a smartphone such as an iPhone or an Android, Bloomberg terminal, Internet Explorer, Chrome, Firefox, and so forth. In various implementations, the aggregators 50 and/or the platform/browsers 60 may be capable of independently providing tiered levels of access (e.g., tiered levels of latency) to content (e.g., content data 14) at different levels of fees/pricing. For example, some current platforms have the ability to provide access to movies once a certain amount of time following the initial release of the movies has passed (e.g., the ability to watch a movie several months after the theatrical movie through iTunes for a fixed fee). But such conventional systems do not give an individual end user an option to have early access to content (e.g., a movie) by paying a higher fee.

In contrast, the platforms/browsers 60 as well as the aggregators 50 illustrated in FIG. 1 may be capable of independently providing multiple levels of access (e.g., providing multiple levels of latency such as one day, one week, one month, two month, and so forth of latency after theatrical release of a movie) to content that are associated with multiple levels of fess or costs. That is, these platform/browsers 60 and/or aggregators 50 may be capable of providing to an end user (e.g., content consumer 70) an option to get earlier access to content if the end user chooses to pay higher fees for such early access. In order to facilitate such functionalities, the illustrated platform/browsers 60 may include certain logic modules including an access level selection presenting module 6-102, an access level selection receiving module 6-104, and/or a content access level providing module 6-106 (which may further include an access level selection receiving module 6-107). As further illustrated in FIG. 1, aggregators 50 may also include similar logic modules (e.g., an access level selection presenting module 7-102, an access level selection receiving module 7-104, and/or a content access level providing module 7-106 that may further include an access level selection receiving module 7-107) in order to perform similar functionalities.

Ultimately, the final consumers of content in the illustrated environment of FIG. 1 may be content consumers 70. Examples of content consumers 70 include, for example, individual end user such as individual persons, or companies such as Goldman Sachs, JP Morgan, PIMCO, DE Shaw, Exxon Mobile, BP, Sinopec, or government agencies such as FBI and Homeland Security Administration. In some cases, content consumers 70 may select the type of fees and access to content that they may wish to access using a convenient slider interface. FIG. 1 illustrates an example “slider” (e.g., example slider 90) for selecting a particular access level (e.g., latency level) for a particular fee. The example slider 90 may be moved by an individual end user using, for example, a mouse or by a finger if it is being displayed on a touchscreen. Such a “slider” tool may be particularly useful for selecting different levels of content access (e.g., different levels of latency) and fees. Note that in alternative implementations, a knob, a dial, or other devices may be employed in order to select different levels of access (e.g., different amounts of latency) and fees. The slider 90 may provide a wide range of access/fee levels from two or three different access/fee levels to continuous different levels of access/fees (e.g., 10, 100, 1000, and so forth, levels of access/fees).

For example, imagine if all subscriptions on the Internet were expressed in the form of a slider 90. An individual end user could then go to the Internet page of, for example, a well-known New York based Newspaper and may get free access to its content by sliding the slider 90 all the way to the left. However, if the individual end user wishes slighter greater access (e.g., quicker access and/or additional data) to the content, then the individual end user may slide the slider slightly to the right (e.g., for every millimeter that you slide to the right, the charge/fee may increase incrementally).

In some instances, an individual end user may be charged in accordance with the movement/position of the slider 90 as well as the individual end user's connection capabilities. For example, if the individual end user is a trader with fiber optic connection, then the trader may be charged relatively higher fees than others particularly if the others don't have the same type of connections and can't get the type of access (e.g., very quick or low latency) that the trader has. In some cases, the top access or greatest access (e.g., shortest latency) through the slider 90 (e.g., if the slider 90 is moved all the way to the right) may be prohibitively expensive and may only be affordable to certain customers such as government agencies or financial institutions.

Although not illustrated in the example slider 90 of FIG. 1, other options other than access/fee levels may be selected by the slider 90. For example, in some implementations, the slider 90 may be used in order to select the type of content to be accessed, the mode of delivery of the content, and/or follow on things regarding the way the content (e.g., content page) is presented (e.g., such as if the slider 90 is moved all the way to the right, then presenting a page with the latest updates, a blog that requires manual click of users in real time updates might instead get automatically presented in real time).

1. (canceled)

2. (canceled)

3. A computationally-implemented method, comprising:
generating, through a network system, at least one bidding tag that is designed to solicit one or more bids for accessing a content that is being offered for consumption, at least in part, through the at least one bidding tag, the one or more bids to be solicited being one or more requests for accessing the content with one or more content access latencies and for one or more respective fees, and the content being offered for consumption being offered for access at different levels of content access latencies;
distributing, from the network system, the at least one bidding tag to two or more computer platforms;
presenting, through at least one or more of the two or more computer platforms, at least an option for selecting at least one level of access for accessing the content, the at least one level of access for accessing the content to be selected being associated with a particular amount of content access latency and a particular amount of fee, the option being presented in response, at least in part, to the distribution of the at least one bidding tag;
receiving, from one or more content consumers and through the one or more computer platforms as a result, at least in part, of presenting at least the option, one or more submitted bids for accessing the content at one or more levels of access that are associated with one or more particular amounts of content access latencies and one or more respective amounts of fees;
providing, from the one or more computing platforms and to the network system, the one or more submitted bids;
releasing, from the network system and to the one or more computer platforms, the content, the content being released in response, at least in part, to the one or more submitted bids;
presenting, through the one or more computer platforms, the content.

4. The computationally-implemented method of claim 3, wherein said generating, through a network system, at least one bidding tag that is designed to solicit one or more bids for accessing a content that is being offered for consumption, at least in part, through the at least one bidding tag, the one or more bids to be solicited being one or more requests for accessing the content with one or more content access latencies and for one or more respective fees, and the content being offered for consumption being offered for access at different levels of content access latencies comprises:
generating the at least one bidding tag by generating at least one bidding tag that at least partially identifies the content being offered for consumption.

5. The computationally-implemented method of claim 3, wherein said generating, through a network system, at least one bidding tag that is designed to solicit one or more bids for accessing a content that is being offered for consumption, at least in part, through the at least one bidding tag, the one or more bids to be solicited being one or more requests for accessing the content with one or more content access latencies and for one or more respective fees, and the content being offered for consumption being offered for access at different levels of content access latencies comprises:
generating the at least one bidding tag by generating at least one bidding tag that at least identifies the content being offered for consumption as news.

6. The computationally-implemented method of claim 3, wherein said generating, through a network system, at least one bidding tag that is designed to solicit one or more bids for accessing a content that is being offered for consumption, at least in part, through the at least one bidding tag, the one or more bids to be solicited being one or more requests for accessing the content with one or more content access latencies and for one or more respective fees, and the content being offered for consumption being offered for access at different levels of content access latencies comprises:
generating the at least one bidding tag by generating at least one bidding tag that at least identifies the content being offered for consumption as consumable media.

7. The computationally-implemented method of claim 6, wherein said generating the at least one bidding tag by generating at least one bidding tag that at least identifies the content being offered for consumption as consumable media comprises:
generating at least the one bidding tag that at least identifies the content being offered for consumption as consumable media by generating at least one bidding tag that at least identifies the content being offered for consumption as a movie.

8. The computationally-implemented method of claim 3, wherein said generating, through a network system, at least one bidding tag that is designed to solicit one or more bids for accessing a content that is being offered for consumption, at least in part, through the at least one bidding tag, the one or more bids to be solicited being one or more requests for accessing the content with one or more content access latencies and for one or more respective fees, and the content being offered for consumption being offered for access at different levels of content access latencies comprises:
generating, through the network system, the at least one bidding tag by generating the at least bidding tag through one or more network servers.

9. The computationally-implemented method of claim 3, wherein said generating, through a network system, at least one bidding tag that is designed to solicit one or more bids for accessing a content that is being offered for consumption, at least in part, through the at least one bidding tag, the one or more bids to be solicited being one or more requests for accessing the content with one or more content access latencies and for one or more respective fees, and the content being offered for consumption being offered for access at different levels of content access latencies comprises:
generating the at least one bidding tag that is designed to solicit one or more bids that are one or more requests for accessing the content with one or more content access latencies and for one or more respective fees by generating at least one bidding tag that is designed to solicit one or more fixed bids for accessing the content at one or more fixed content access latencies and at one or more fixed fees.

10. The computationally-implemented method of claim 3, wherein said generating, through a network system, at least one bidding tag that is designed to solicit one or more bids for accessing a content that is being offered for consumption, at least in part, through the at least one bidding tag, the one or more bids to be solicited being one or more requests for accessing the content with one or more content access latencies and for one or more respective fees, and the content being offered for consumption being offered for access at different levels of content access latencies comprises:
generating the at least one bidding tag that is designed to solicit one or more bids that are one or more requests for accessing the content with one or more content access latencies and for one or more respective fees by generating at least one bidding tag that is designed to solicit one or more open bids for accessing the content at one or more requested content access latencies and at one or more requested fees.

11. The computationally-implemented method of claim 3, wherein said distributing, from the network system, the at least one bidding tag to two or more computer platforms comprises:
distributing the at least one bidding tag to the two or more computer platforms by distributing the at least bidding tag to at least an electronic trading platform.

12. The computationally-implemented method of claim 3, wherein said distributing, from the network system, the at least one bidding tag to two or more computer platforms comprises:
distributing the at least one bidding tag to the two or more computer platforms by distributing the at least one bidding tag to at least a mobile computing device.

13. The computationally-implemented method of claim 3, wherein said presenting, through at least one or more of the two or more computer platforms, at least an option for selecting at least one level of access for accessing the content, the at least one level of access for accessing the content to be selected being associated with a particular amount of content access latency and a particular amount of fee, the option being presented in response, at least in part, to the distribution of the at least one bidding tag comprises:
presenting through the at least one or more computer platforms at least the option for selecting at least one level of access for accessing the content by presenting through the at least one or more computer platforms at least an option for selecting a level of access for accessing content from a plurality of tiered levels of access for accessing the content, each of the tiered levels of access being associated with a different amount of content access latency and a different amount of fee.

14. The computationally-implemented method of claim 3, wherein said presenting, through at least one or more of the two or more computer platforms, at least an option for selecting at least one level of access for accessing the content, the at least one level of access for accessing the content to be selected being associated with a particular amount of content access latency and a particular amount of fee, the option being presented in response, at least in part, to the distribution of the at least one bidding tag comprises:
presenting through the one or more computer platforms the option for selecting at least one level of access for accessing the content by presenting through the one or more computer platforms at least a graphical user interface (GUI) for selecting the at least one level of access for accessing the content.

15. The computationally-implemented method of claim 14, wherein said presenting through the one or more computer platforms the option for selecting at least one level of access for accessing the content by presenting through the one or more computer platforms at least a graphical user interface (GUI) for selecting the at least one level of access for accessing the content comprises:
presenting through the one or more computer platforms the GUI for selecting the at least one level of access for accessing the content by presenting through the one or more computer platforms a slider feature having an elongated element and a slider element that is designed to be moveable, in response to user input, along the length of the elongated element having a first end and a second end at opposite ends of the length of the elongated element, the slider element being designed to be moved along the length of the elongated element from the first end to the second end to select the level of access for accessing the content.

16. The computationally-implemented method of claim 15, wherein said presenting through the one or more computer platforms the GUI for selecting the at least one level of access for accessing the content by presenting through the one or more computer platforms a slider feature having an elongated element and a slider element that is designed to be moveable, in response to user input, along the length of the elongated element having a first end and a second end at opposite ends of the length of the elongated element, the slider element being designed to be moved along the length of the elongated element from the first end to the second end to select the level of access for accessing the content comprises:
presenting through the one or more computer platforms the slider feature having the elongated element and the slider element that is designed to be moveable, in response to user input, along the length of the elongated element having the first end and the second end at opposite ends of the length of the elongated element by presenting through the one or more computer platforms a slider feature that includes a slider element that is designed to be moveable, in response to user input, along the length of the elongated element having the first end and the second end and having multiple points along the length of the elongated element including the first end and the second end, the multiple points along the length of the elongated element from the first end to the second end being associated with graduated levels of access for accessing the content with varying amounts of latencies for accessing the content and varying amounts of associated fees, the first end corresponding to highest level of access that is available along the elongated element for accessing the content with lowest amount of latency and highest fee that are available along the elongated element and the second end corresponding to lowest access available along the elongated element for accessing the content with highest amount of latency and lowest fee that are available along the elongated element, and each point along the elongated element from the second end to the first end corresponding to incrementally increasing levels of access for accessing the content with decreasing amounts of latencies and increasing amounts of associated fees.

17. The computationally-implemented method of claim 14, wherein said presenting through the one or more computer platforms the option for selecting at least one level of access for accessing the content by presenting through the one or more computer platforms at least a graphical user interface (GUI) for selecting the at least one level of access for accessing the content comprises:
presenting through the one or more computer platforms at least the GUI for selecting the at least one level of access for accessing the content by presenting through the one or more computer platforms at least a GUI for selecting the at least one level of access for accessing the content from a plurality of indicated graduated levels of access for accessing the content.

18. The computationally-implemented method of claim 3, wherein said receiving, from one or more content consumers and through the one or more computer platforms as a result, at least in part, of presenting at least the option, one or more submitted bids for accessing the content at one or more levels of access that are associated with one or more particular amounts of content access latencies and one or more respective amounts of fees comprises:
receiving the one or more submitted bids by receiving one or more selections of one or more levels of content access that are associated with one or more levels of content access latencies and fees.

19. The computationally-implemented method of claim 18, wherein said receiving the one or more submitted bids by receiving one or more selections of one or more levels of content access that are associated with one or more levels of content access latencies and fees comprises:
receiving the one or more selections of the one or more levels of content access that are associated with the one or more levels of content access latencies and fees by receiving the one or more selections through a touchscreen or a mouse.

20. The computationally-implemented method of claim 3, wherein said releasing, from the network system and to the one or more computer platforms, the content, the content being released in response, at least in part, to the one or more submitted bids comprises:
releasing the content to the one or more computing platforms by transmitting the content to the one or more computing platforms.

21. The computationally-implemented method of claim 3, wherein said releasing, from the network system and to the one or more computer platforms, the content, the content being released in response, at least in part, to the one or more submitted bids comprises:
releasing the content to the one or more computing platforms by providing access to the content to the one or more computing platforms.

22. The computationally-implemented method of claim 3, wherein said releasing, from the network system and to the one or more computer platforms, the content, the content being released in response, at least in part, to the one or more submitted bids comprises:
releasing the content to the one or more computer platforms in response, at least in part, to the one or more submitted bids by releasing the content to a plurality of computer platforms in accordance, at least in part, with the one or more submitted bids.

23. The computationally-implemented method of claim 22, wherein said releasing the content to the one or more computer platforms in response, at least in part, to the one or more submitted bids by releasing the content to a plurality of computer platforms in accordance, at least in part, with the one or more submitted bids comprises:
releasing the content to the plurality of computer platforms in accordance, at least in part, with the one or more submitted bids by releasing the content to the plurality of computer platforms at different points in time in accordance, at least in part, with the one or more submitted bids.

24. The computationally-implemented method of claim 22, wherein said releasing the content to the one or more computer platforms in response, at least in part, to the one or more submitted bids by releasing the content to a plurality of computer platforms in accordance, at least in part, with the one or more submitted bids comprises:
releasing the content to the plurality of computer platforms in accordance, at least in part, with the one or more submitted bids by releasing the content to different groups of content platforms at different points in time.

25. The computationally-implemented method of claim 3, wherein said releasing, from the network system and to the one or more computer platforms, the content, the content being released in response, at least in part, to the one or more submitted bids comprises:
releasing the content to the one or more computer platforms including releasing to the one or more computer platforms contextual data related to the content.

26. The computationally-implemented method of claim 25, wherein said releasing the content to the one or more computer platforms including releasing to the one or more computer platforms contextual data related to the content comprises:
releasing to the one or more computer platforms contextual data related to the content by releasing to the one or more computer platforms historical information related to the content.

27. The computationally-implemented method of claim 26, wherein said releasing to the one or more computer platforms contextual data related to the content by releasing to the one or more computer platforms historical information related to the content comprises:
releasing to the one or more computer platforms the historical information related to the content by releasing to the one or more computer platforms historical market data related to the content, where the content is financial market data.

28. The computationally-implemented method of claim 3, wherein said releasing, from the network system and to the one or more computer platforms, the content, the content being released in response, at least in part, to the one or more submitted bids comprises:
releasing the content to the one or more computer platforms including releasing to the one or more computer platforms information related to one or more content consumers who have previously accessed the content.

29. The computationally-implemented method of claim 28, wherein said releasing the content to the one or more computer platforms including releasing to the one or more computer platforms information related to one or more content consumers who have previously accessed the content comprises:
releasing to the one or more computer platforms the information related to the one or more content consumers who have previously accessed the content by releasing to the one or more computer platforms information that indicates identity or identities of the one or more content consumers who have previously accessed the content.

30. The computationally-implemented method of claim 28, wherein said releasing the content to the one or more computer platforms including releasing to the one or more computer platforms information related to one or more content consumers who have previously accessed the content comprises:
releasing to the one or more computer platforms the information related to the one or more content consumers who have previously accessed the content by releasing to the one or more computer platforms information that indicates the number of the one or more content consumers who have previously accessed the content.

31. The computationally-implemented method of claim 3, wherein said releasing, from the network system and to the one or more computer platforms, the content, the content being released in response, at least in part, to the one or more submitted bids comprises:
releasing the content to the one or more computer platforms by releasing the content to a first group of computer platforms at a first point in time and releasing the content to a second group of computer platforms at a second point in time, where the first point in time is earlier than the second point in time, and further releasing to the second group of computer platforms information related to content consumers associated with the first group of computer platforms.

32. A computationally-implemented system, comprising:
means for generating, through a network system, at least one bidding tag that is designed to solicit one or more bids for accessing a content that is being offered for consumption, at least in part, through the at least one bidding tag, the one or more bids to be solicited being one or more requests for accessing the content with one or more content access latencies and for one or more respective fees, and the content being offered for consumption being offered for access at different levels of content access latencies;
means for distributing, from the network system, the at least one bidding tag to two or more computer platforms;
means for presenting, through at least one or more of the two or more computer platforms, at least an option for selecting at least one level of access for accessing the content, the at least one level of access for accessing the content to be selected being associated with a particular amount of content access latency and a particular amount of fee, the option being presented in response, at least in part, to the distribution of the at least one bidding tag;
means for receiving, from one or more content consumers and through the one or more computer platforms as a result, at least in part, of presenting at least the option, one or more submitted bids for accessing the content at one or more levels of access that are associated with one or more particular amounts of content access latencies and one or more respective amounts of fees;
means for providing, from the one or more computing platforms and to the network system, the one or more submitted bids;
means for releasing, from the network system and to the one or more computer platforms, the content, the content being released in response, at least in part, to the one or more submitted bids; and
means for presenting, through the one or more computer platforms, the content.

33. A system, comprising:
circuitry for generating, through a network system, at least one bidding tag that is designed to solicit one or more bids for accessing a content that is being offered for consumption, at least in part, through the at least one bidding tag, the one or more bids to be solicited being one or more requests for accessing the content with one or more content access latencies and for one or more respective fees, and the content being offered for consumption being offered for access at different levels of content access latencies;
circuitry for distributing, from the network system, the at least one bidding tag to two or more computer platforms;
circuitry for presenting, through at least one or more of the two or more computer platforms, at least an option for selecting at least one level of access for accessing the content, the at least one level of access for accessing the content to be selected being associated with a particular amount of content access latency and a particular amount of fee, the option being presented in response, at least in part, to the distribution of the at least one bidding tag;
circuitry for receiving, from one or more content consumers and through the one or more computer platforms as a result, at least in part, of presenting at least the option, one or more submitted bids for accessing the content at one or more levels of access that are associated with one or more particular amounts of content access latencies and one or more respective amounts of fees;
circuitry for providing, from the one or more computing platforms and to the network system, the one or more submitted bids;
circuitry for releasing, from the network system and to the one or more computer platforms, the content, the content being released in response, at least in part, to the one or more submitted bids; and
circuitry for presenting, through the one or more computer platforms, the content.
